(19) United States
(12) Patent Application Publication
(10) Pub. No.: US 2026/0116274 A1
(43) Pub. Date: Apr. 30, 2026

(54) Integrated Child Carrier for a Vehicle Seat

(71) Applicant: E.V.S. Ltd., South Bend, IN (US)

(72) Inventors: David P. Carlson, Elkhart, IN (US); Karter M. Kistler, Mishawaka, IN (US); Taylor A. Kaminski, New Carlisle, IN (US)

(21) Appl. No.: 18/926,666

(22) Filed: Oct. 25, 2024

(51) Int. Cl. B60N 2/30

(52) U.S. Cl. CPC B60N 2/3081

(57) ABSTRACT

The child carrier integrates into a vehicle seat for use as either an upright toddler seat or a reclined infant cradle for safely transporting children while being conveniently stowed within the adult seat back when not in use. The child carrier includes a seat/cradle and two sets of identical right and left side linkages that allow the seat/cradle to extend outward from a stowed position within the adult seat back into a reclined deployed position. The child carrier also includes separate locking mechanisms that securely locks the seat/cradle in either the stowed and the deployed positions. One locking mechanism physically engages the side linkages to prevent the linkages from in inadvertently collapsing or extending thereby holding the seat/cradle in the desired position.

This invention relates to a vehicle seat for use in emergency response vehicles and common carrier vehicles and specifically to an integrated child carrier that deploys as either a child seat or infant cradle.

### BACKGROUND AND SUMMARY OF THE INVENTION

It is often necessary to transport non-patient infants in emergency response vehicles, such as ambulances, fire/rescue trucks and boats, helicopters and airplanes. Many conventional safety chairs used in an emergency response vehicle are configurable to carry both adults and small children, but infants typically require special carriers or “infant car seats” that are strapped atop the safety chair's seat. The dangers of transporting infants without proper safety seating is well-known and often illegal in most jurisdictions in the United States. While, emergency response vehicles are often exempt from such restrictions, an infant can be seriously injured if the emergency response vehicle is involved in an accident while the infant is being carried outside a proper infant safety seat.

The child carrier of this invention integrates into a vehicle seat for use as either an upright toddler seat or a reclined infant cradle for safely transporting children while being conveniently stowed within the adult seat back when not in use. The child carrier includes a seat/cradle and two sets of identical right and left side linkages that allow the seat/cradle to extend outward from a stowed position within the adult seat back into a reclined deployed position. The child carrier also includes separate locking mechanisms that securely locks the seat/cradle in either the stowed and the deployed positions. One locking mechanism physically engages the side linkages to prevent the linkages from in inadvertently collapsing or extending thereby holding the seat/cradle in the deployed position.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of a vehicle seat having an exemplary embodiment of the child carrier of the invention integrated into the seat back and shown in the stowed position;

FIG. 2 is a perspective view of the vehicle seat and child carrier of FIG. 1 showing the seat/cradle in the deployed position;

FIG. 3 is a rear perspective view of the seat back frame and child carrier frame of the vehicle seat of FIG. 1 showing the seat/cradle in the stowed position;

FIG. 4 is a rear perspective view of the seat back frame and child carrier frame of the vehicle seat of FIG. 1 showing the seat/cradle in the deployed position;

FIG. 5 is a rear plan view of the seat back frame and child carrier frame of FIG. 1 showing the locking mechanism in an extended (locked) position;

FIG. 6 is a rear plan view of the seat back frame and child carrier frame of FIG. 1 showing the locking mechanism in a retracted (unlocked) position;

FIG. 7 is a partial perspective view of the locking mechanism of the child carrier of FIG. 1 showing the plunger pin engaging the linkage of the child carrier; and

FIG. 8 is a partial perspective view of the locking mechanism of the child carrier of FIG. 1 showing the plunger pin disengaging the linkage of the child carrier.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

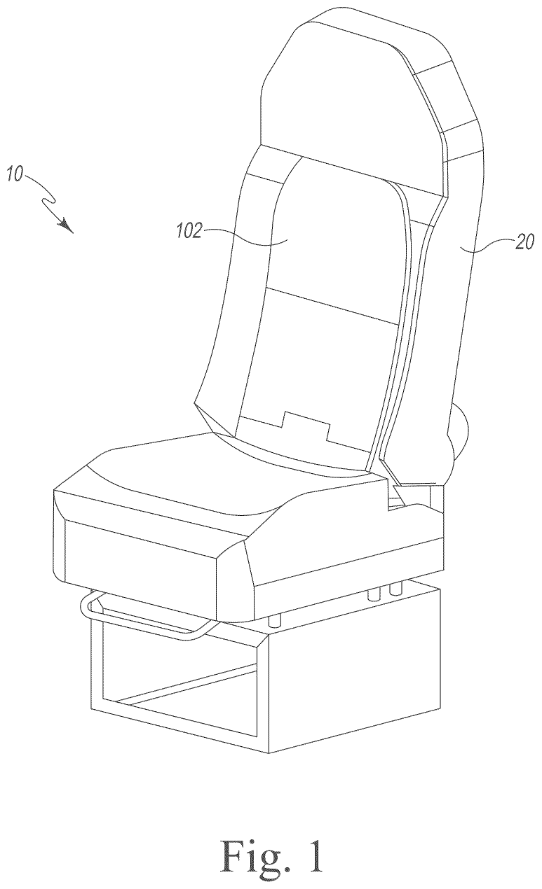

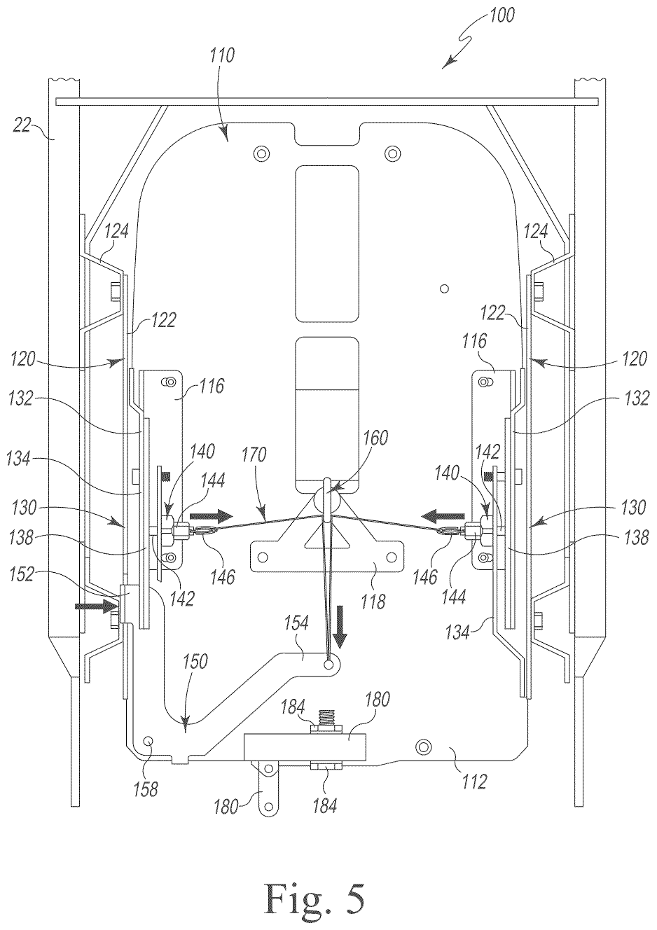

Referring now to the drawings, FIGS. 1-8 illustrate an exemplary embodiment of the child carrier of this invention, which is designated generally as reference numeral 100. For simplicity of illustration and explanation, child carrier 100 shown integrated into the seat back 20 of a conventional vehicle seat 10, which is of the type commonly used in emergency response vehicles well known in the art. In other embodiments, the child carriers of this invention may be adapted for use in other types of vehicle seats and a variety of other transportation applications. but are ideally suited for use in emergency response vehicles, such as ambulances, fire/rescue trucks and boats, helicopters and airplanes. In addition, the child carrier of this invention may also be used as a wall or seat mounted unit, or be integrated directly into the design of a conventional vehicle seat.

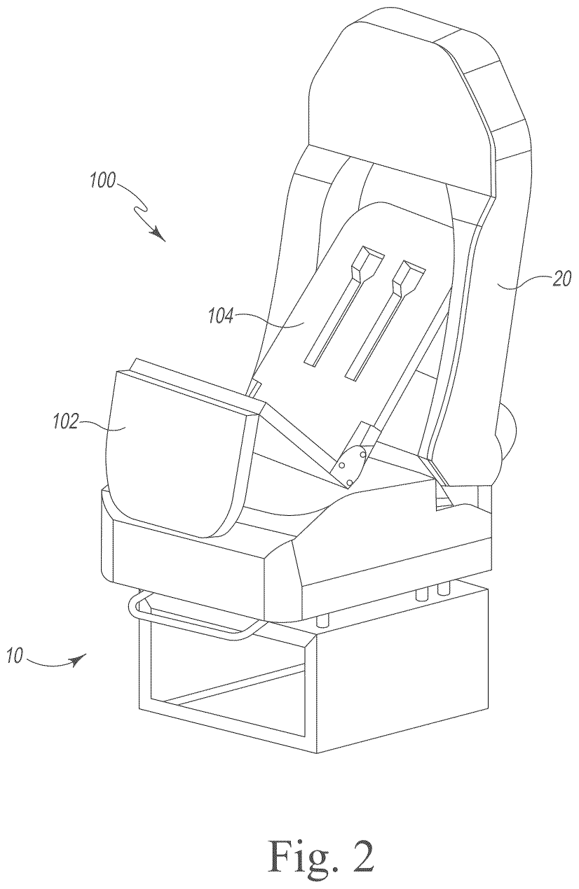

Child carrier 100 allows a conventional adult emergency vehicle seat to be used to safely transport toddlers and infants while being conveniently stowed within the seat back when not in use. Child carrier 100 is designed and intended to safely transport either an infant or toddler generally under the weight of 65 lbs. As shown, child carrier 100 includes a seat/cradle 110 that manually deploys outward from a stowed position (FIG. 1) within seat back 20 to a deployed position (FIG. 2). In addition, seat/cradle 110 unfolds in the stowed position to provide an upright seat for toddlers (not shown), and also unfolds in the deployed position to provide a reclined cradle for infants.

Child carrier 100 is generally constructed or fabricated from sheet metal, such as stainless steel or aluminum, but may be formed or molded from a polymer plastic. The materials are selected to provide a pliable, yet sturdy base for carrying an infant that can be easily cleaned and disinfected. Typically, child carrier 100 is covered by a removable padded liner or covering 102 forms part of the adult seat back cushion (FIG. 1). Child carrier also includes a foam pad or covering 104 that encloses any exposed surfaces of the carrier, but also moves and folds with the carrier (FIG. 2).

Child carrier 100 includes a carrier sub-frame 120 that connects seat/cradle 110 to internal seat back frame 22 of seat back 20. Carrier sub-frame 120 includes a pair of upright side members 122 mounted to seat back frame 22 by off-set brackets 124. Child carrier 100 also includes its own safety belting system (not shown), which is separate and independent from the adult safety belt system (also not fully shown) of seat 10. The child carrier belting system is of the type developed by E.V.S. Itd of South Bend Indiana, and disclosed in U.S. Pat. No. 11,993,185. The child carrier belting system mounts to seat/cradle 110 as an integral part of child carrier 100. The child carrier belting systems stows inside the collapsed child carrier 100 when not in use, but is readily available once child carrier 100 is deployed and/or unfolded.

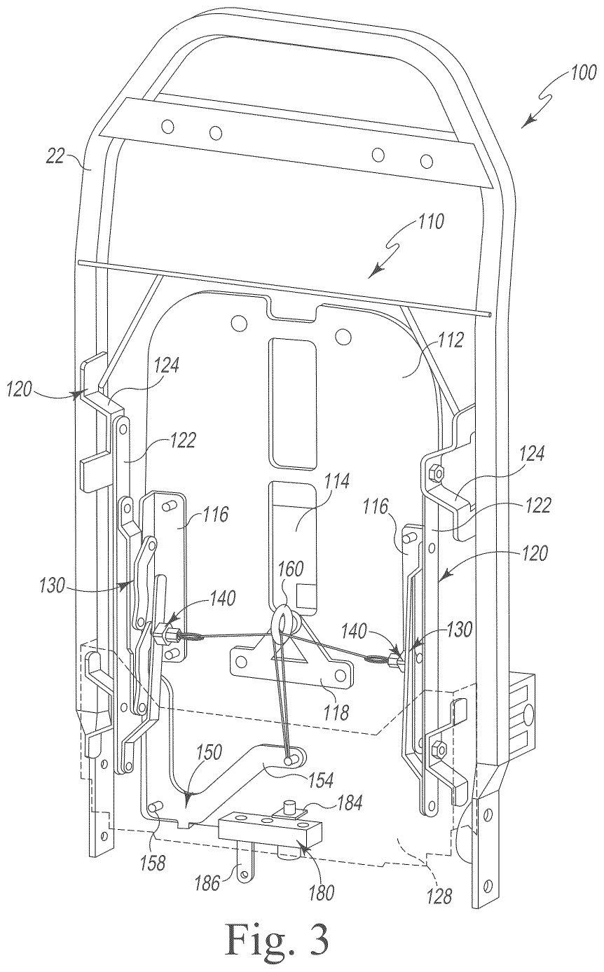

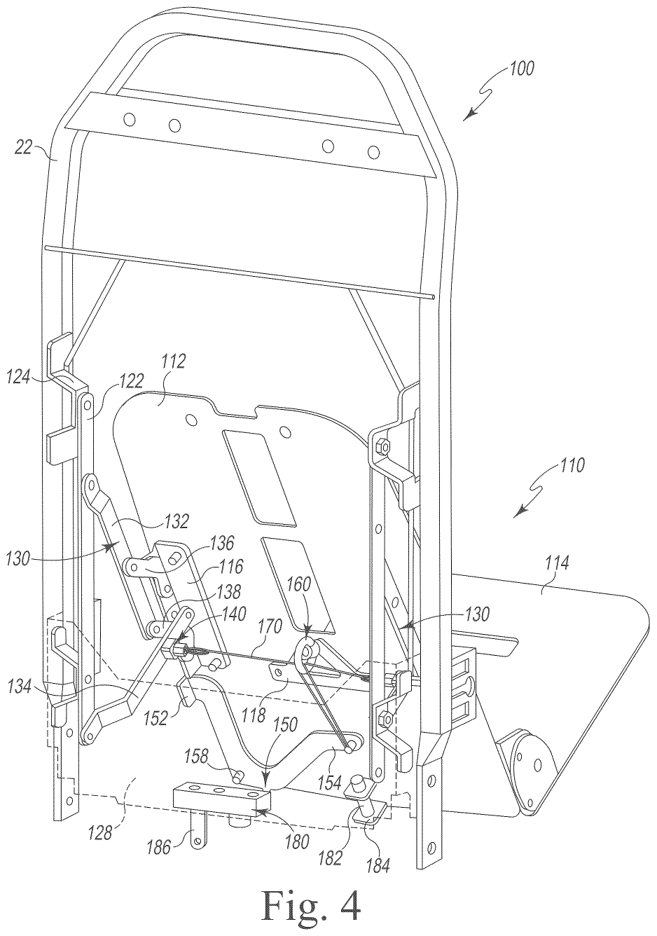

Seat/cradle 110 includes a flat back panel 112 and a flat seat panel 114 are pivotally connect by a pair of bolt fasteners that extend through aligned holes in the side walls of each panel. Seat panel 114 is hinged to back panel 112 for movement between the folded position where the seat panel lies flat over the back panel (FIG. 3) and an unfolded position where the seat panel extends from the back panel (FIG. 4). Seat/cradle 110 has a protective covering (not shown) that encloses back panel 112 and seat panel 114. Seat cradle 110 also includes a pair of brackets (left and right) 116 affixed to the back of back panel 112.

Seat/cradle 110 is connected to sub-frame 120 by two sets of identical right and left side linkages 130. Side linkages 130 are mounted to the sides of both seat/cradle 110 and sub-frame 120 and allow seat/cradle 110 to extend outward from seat back 20 and recline into the deployed position (FIG. 4). Each side linkage 130 includes two straight link arms 132 and 134 and two L-shaped parallelogram link arms 136 and 138. Link arms 132, 134, 136 and 138 are pivotally interconnected by conventional pins, rivets, bolts and spacers, which allow side linkages 130 to expand and contract. Linkage arms 132, 134, 136 and 138 also all have various joggles and bends that allow them to overlap in a compact footprint when contracted. Link arm 134 is pivotally connected at one end to upright side member 122 and at the opposite end to linkage bracket 116 mounted to back panel bracket 116. Link arm 132 is pivotally connected at one end to upright side member 122. Each parallelogram link arm 136 and 138 is pivotally connected at one end to link arm 132 and at the opposite end to back panel bracket 116. Link arm 136 is connected at the mid point of link arm 132 and link arm 138 is connected to the opposite end of link arm 132. The pivot points of link arms 136 and 138 are equal distanced and parallel to one another, which allows seat back panel 112 to move parallel to link arm 132. Link arm 134 pivots to kick seat back panel 112 outward into the reclined folded position.

Child carrier 100 includes a locking mechanism for securely locking seat/cradle 110 in the deployed position. The deployed locking mechanism includes a pair of spring-loaded plunger latches 140 that physically engages linkage 130 to prevent side linkages 130 from extending or collapsing back onto themselves to hold seat/cradle 110 in position. Plunger latches 140 includes a reciprocating pin 142 seated within a hollow plunger body 144. Plunger latches 140 are affixed to link arm 134 so that the exposed end of pin 142 protrudes through link arm 134. The opposite end of pin 142 is connected to a plunger ring 146. Pin 142 is biased to extend outward by an internal plunger spring (not shown) inside plunger body 144. Manually pulling on plunger ring 146 retracts pin 142 into plunger housing 144 against the force of the internal plunger spring.

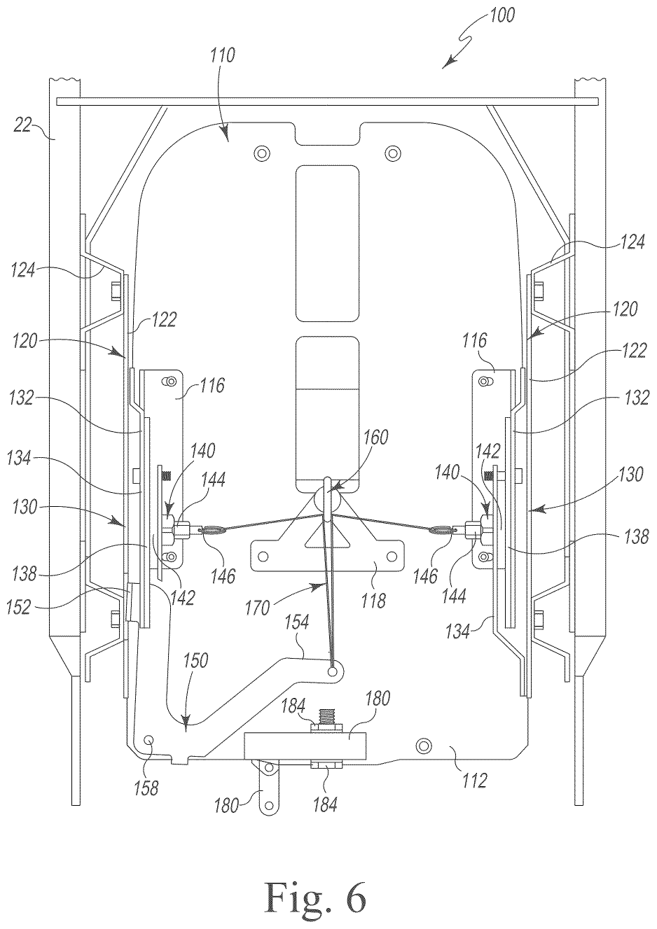

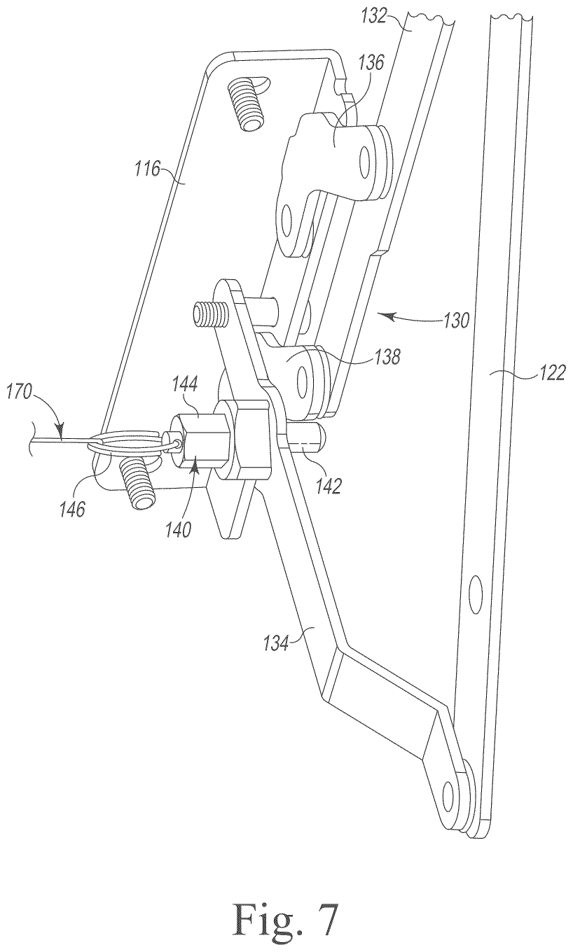

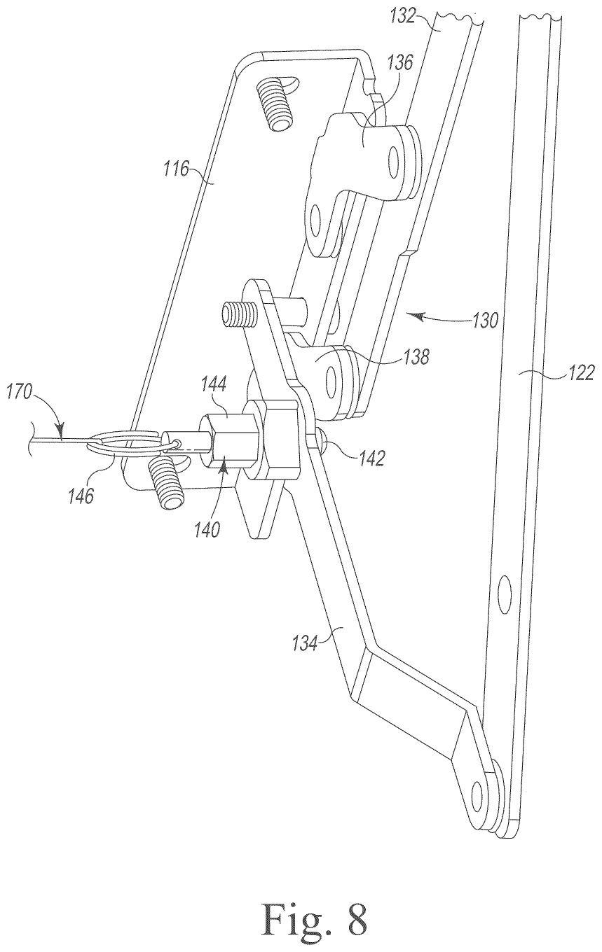

The deployment locking mechanism also includes a pivoting latch lever 150, a cable eyelet 160 and a pair of pull cables 170. Latch lever 150 is pivotally connected to the back side of back panel 112 beneath one of side linkages 130. Latch lever 150 has a V-shaped configuration with a release end 152 position adjacent one side of back panel 112 and a cable end 154 centrally spaced over back panel 112. Latch lever 150 pivots about a pivot pin 158 so that latch lever 150 rotates within the plane of back panel 112. Cable eyelet 160 is mounted to a central bracket 118 affixed to the back of back panel 112. One end of each cable 170 is connected to cable end 154 of latch lever 150. The other end of cables 170 passes through cable eyelet 160, in opposite directions, and is affixed to one of plunger ring 146. In the deployed position as best shown in FIG. 7, linkage arms 136 seat against the top extended plunger pins 142, which prevent linkage 130 from collapsing and physically holds seat/cradle 110 in the deployed position. As best shown in FIGS. 6 and 8, manually pressing release end 152 inward rotates latch lever 150 pulling cables 170 to simultaneously withdraws plunger pins 142 from engagement under linkage 138 and allow linkage 130 to collapse and seat/cradle 110 to be manually moved into the stowed position.

Child carrier 100 also includes a separate locking mechanism for securely locking seat/cradle 110 in the stowed position within seat back 20. The stowed locking mechanism includes a rotator latch 180 that captures a pin 182 to physically prevent seat/cradle 110 from inadvertently moving into the deployed position. Latch 180 is mounted to a cross panel 128 mounted to sub-frame 120. Pin 182 is mounted to the back side of carrier back panel 112 by a brackets 184. Rotator latch 180 is of convention design and function and includes a latch lever 186. Manually actuating latch lever 186 from under the bottom of seat/cradle 110 causes rotator latch 180 to release pin 182 allowing the seat/cradle to move from the stowed position to the deployed position.

It should be apparent from the foregoing that an invention having significant advantages has been provided. While the invention is shown in only a few of its forms, it is not limited to, but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

We claim:

1. In a vehicle seat for an adult having a seat back, a child carrier mounted to the seat back frame for movement between a stowed position disposed within the seat back and a deployed position extending outward from the seat back, the child carrier comprising:
a seat/cradle;
a plurality of linkage arms connecting the seat/cradle to the seat back for moving the seat/cradle between a stowed position where the seat/cradle is disposed within the seat back and a deployed position where the seat/cradle extends outward from the seat back; and
a locking mechanism operatively connected to the seat/cradle and the plurality of linkage arms for securely locking the seat/cradle in the deployed position, the locking mechanism including a latch plunger carried by one of the plurality of linkage arms and having a reciprocal pin movable from an extended position to abut against another of the plurality of linkage arms to securely hold the seat/cradle in the deployed position and a retracted position spaced from the other of the plurality of linkage arms to allow the seat/cradle to move between the deployed position and the stowed position.

2. The child carrier of claim 1 and a sub-frame connecting the seat back to the plurality of linkage arms.

3. The child carrier of claim 1 wherein the plurality of linkage arms includes a first linkage arm pivotally connected between the seat back and the seat/cradle, a second linkage arm pivotally connected to the seat back, and a third linkage arm pivotally connected between the seat/cradle and second linkage arm.

4. The child carrier of claim 3 wherein the latch plunger is mounted to the first linkage arm.

5. The child carrier of claim 4 wherein the reciprocal pin abuts against the third linkage arm when the seat/cradle is in the deployed position.

6. The child carrier of claim 1 wherein the locking mechanism also includes a latch lever pivotally connected to the seat/cradle and operatively connected to the latch plunger.

7. The child carrier of claim 6 wherein the latch lever is connected to the latch plunger by a cable.

8. The child carrier of claim 7 wherein the seat/cradle includes an eyelet, the cable passes through the eyelet between the latch plunger and the latch lever.

9. The child carrier of claim 1 wherein the seat/cradle includes a back panel and a seat panel hinged to the back panel for movement between the folded position where the seat panel lies flat over the back panel and an unfolded position where the seat panel extends from the back panel.

10. The vehicle seat of claim 9 wherein the seat/cradle is in the first position and the seat panel is in the unfolded position when the child carrier is in the deployed position to carry the child in an upright position, the seat/cradle is in the second position and the seat panel is in the unfolded position when the child carrier is in the deployed position to carry the child in a reclined position.

11. The vehicle seat of claim 9 wherein the seat/cradle is in the first position and the seat panel is in the folded position when the child carrier is in the stowed position.

12. A vehicle seat comprising:
a seat back for receiving an adult; and
a child carrier for receiving a child and mounted to the seat back frame for movement between a stowed position disposed within the seat back and a deployed position extending outward from the seat back, the child carrier includes
a seat/cradle,
a plurality of linkage arms connecting the seat/cradle to the seat back for moving the seat/cradle between a stowed position where the seat/cradle is disposed within the seat back and a deployed position where the seat/cradle extends outward from the seat back; and
a locking mechanism operatively connected to the seat/cradle and the plurality of linkage arms for securely locking the seat/cradle in the deployed position, the locking mechanism including a latch plunger carried by one of the plurality of linkage arms and having a reciprocal pin movable from an extended position to abut against another of the plurality of linkage arms to securely hold the seat/cradle in the deployed position and a retracted position spaced from the other of the plurality of linkage arms to allow the seat/cradle to move between the deployed position and the stowed position.

13. The vehicle seat of claim 12 and a sub-frame connecting the seat back to the plurality of linkage arms.

14. The vehicle seat of claim 12 wherein the plurality of linkage arms includes a first linkage arm pivotally connected between the seat back and the seat/cradle, a second linkage arm pivotally connected to the seat back, and a third linkage arm pivotally connected between the seat/cradle and second linkage arm.

15. The vehicle seat of claim 14 wherein the latch plunger is mounted to the first linkage arm.

16. The vehicle seat of claim 15 wherein the reciprocal pin abuts against the third linkage arm when the seat/cradle is in the deployed position.

17. The vehicle seat of claim 12 wherein the locking mechanism also includes a latch lever pivotally connected to the seat/cradle and operatively connected to the latch plunger.

18. The child carrier of claim 17 wherein the latch lever is connected to the latch plunger by a cable.

19. The child carrier of claim 18 wherein the seat/cradle includes an eyelet, the cable passes through the eyelet between the latch plunger and the latch lever.

20. The child carrier of claim 12 wherein the seat/cradle includes a back panel and a seat panel hinged to the back panel for movement between the folded position where the seat panel lies flat over the back panel and an unfolded position where the seat panel extends from the back panel.

21. The vehicle seat of claim 20 wherein the seat/cradle is in the first position and the seat panel is in the unfolded position when the child carrier is in the deployed position to carry the child in an upright position, the seat/cradle is in the second position and the seat panel is in the unfolded position when the child carrier is in the deployed position to carry the child in a reclined position.

22. The vehicle seat of claim 21 wherein the seat/cradle is in the first position and the seat panel is in the folded position when the child carrier is in the stowed position.
